(19) United States
(12) Patent Application Publication
(10) Pub. No.: US 2014/0192709 A1
(43) Pub. Date: Jul. 10, 2014

(54) METHODS OF WIRELESS DATA COLLECTION

(71) Applicant: SRD INNOVATIONS INC., Calgary (CA)

(72) Inventors: Ronald Gerald Murias, Calgary (CA); Rashed Haydar, Calgary (CA)

(73) Assignee: SRD INNOVATIONS INC., Calgary (CA)

(21) Appl. No.: 13/734,896

(22) Filed: Jan. 4, 2013

(51) Int. Cl. H04W 84/18

(52) U.S. Cl. CPC H04W 84/18
USPC 370/328

(57) ABSTRACT

A wireless mesh is used to collect data such as from a seismic survey. Data is collected at sensor nodes and transmitted in packets to aggregator nodes, where they are aggregated and transmitted to a central controller or a processing node for processing, in which the data is recorded on a storage device. Packets and aggregate packets may be compressed, encrypted and have wrappers applied, and these steps may be reversed in processing. The central controller distributes packets to multiple processing nodes for processing in parallel.

### TECHNICAL FIELD

Wireless data collection

### BACKGROUND

Large scale wireless mesh networks may be used to harvest data from seismic arrays. Some deployments require real-time collection of the data (often for real-time display), while other scenarios require bulk downloads of large amounts of data stored from each node.

The wireless mesh may consist of more than one layer of radio mesh links 10. FIG. 1 shows the source nodes 12 (circles) feeding data to primary aggregators 14 (L1), which feed secondary aggregators 16 (L2), and finally the secondary aggregators pass the data to the central controller 18 (CC). Some mesh network structures require this multi-tier aggregation system, others may have only one layer of aggregation or allow the mesh nodes to communicate directly with the CC (through the mesh).

One example of a large survey is a 10,000 node survey requiring near real-time streaming of data to the control center, which is then saved to a permanent storage device (such as a hard disk drive). With a 3-channel sensor measuring 32-bit data at a sample rate of 1 sample per millisecond, each node produces 32*3*1000=96,000 bits per second. Note that 10,000 nodes sending data to a control center produces a stream at a rate of 960 Mbps or 120 MB/s, and this is without any overhead (time stamps, node identification, etc.). This incoming data rate is not only a massive load on the wireless network, but receiving, processing, and storing the data is a daunting task for the control center.

Each incoming data packet must be processed and stored on a large capacity non-volatile medium. Current advertised hard drive data transfer rates are as high as 115-119 MB/s. Note that hard disk transfer rates are conducted using one large file and represent the ideal case for file streaming, while the practical example described above would require appending data to from 10,000 different sources to 10,000 different files, which results in far worse performance. The performance requirements alone for storing the data exceed what is currently available, and simply processing the incoming data is also beyond the capacity of a typical general purpose computer.

The wireless seismic mesh described above is also limited in capacity by the amount throughput it can manage. Often, the terrain and node-to-node distances limit the amount of data a node can transfer over a given amount of time. There is a strong need to improve node-to-node throughput, which not only improves overall mesh performance, but in many cases makes the difference between a working network and a network that cannot harvest the data as fast as it is generated.

Another type of deployment, “non-real-time download”, is required in cases where data stored on the nodes or on collectors near the nodes is transferred to the control center, often following the completion of the survey or after a few days of measurements have been conducted. An example of the file structure used with this kind of system is included in the Appendix. In this example, six sensors are connected to a collection device, and each sensor samples up to three channels of 24 bit data.

While simple calculations for a 24-bit sensor may use, for example: (24 bits per sample*sample rate) to calculate required data rates, the actual data stream is more complex than this; it includes readings for possibly unused channels as well as sensor status, headers, and checksum data. The format and structure of the data lends itself to reduction in over-the-air transmission, and therefore an increase in data throughput, reduction of power consumption, an increase in the number of serviceable nodes, or a combination of the above (and other) benefits.

In any wireless environment, there is always some over-the-air packet loss. TCP is one protocol that ensures in-order delivery of all packets by adding sequence numbering and automatic re-transmission requests. TCP is often an excellent choice for a robust protocol and works well for wireless communications. However, the robust reliability of TCP comes with increased overhead that may be inappropriate for seismic data transfer.

One alternative is to incorporate some of the features of TCP using a simpler protocol like UDP. For example, one may implement in-order packet delivery and delivery confirmation/re-try requests at a higher protocol layer while using UDP for the underlying network protocol. In order to do this, some additional information (like sequence numbers) must be added to data packets, and other information (like transmission acknowledgements) must be sent from data receivers to data transmitters.

As mentioned earlier, scaling of the data network is highly dependent on the capacity of the CC to process the incoming data streams. Enabling source, intermediate, or aggregator nodes to perform some pre-processing operations (like stacking, for example) can reduce the data transmission load as well as reducing the effort required for the CC to store the data in file format.

The CC, upon receiving streams from up to 10,000 nodes, needs to employ an efficient method of streaming the packet bundles into individual files, and tracking (and waiting for) missing packets within the bundles adds unnecessary storage requirements and additional processing load.

### SUMMARY

There is disclosed a method of processing an aggregate packet of a stream of aggregate packets, the aggregate packet formed by aggregating plural data packets, the method comprising: a controller selecting a processing engine of a set of processing engines and causing the aggregate packet to be sent to the selected processing engine, processing the aggregate packet at the selected processing engine to recover the plural data packets, and processing the plural data packets at the selected processing engine by appending each of the plural data packets to a respective file on a respective file storage device.

In various embodiments, there may be included any one or more of the following features: the aggregate packet may be received at the controller and sent by the controller to the selected processing engine. The controller may read an aggregate wrapper of the aggregate packet, and the controller may select the processing engine to which to send the aggregate packet based on the aggregate wrapper of the aggregate packet. The aggregate packet may be encrypted and the aggregate packet may be decrypted at the controller before reading the aggregate wrapper of the aggregate packet. The aggregate packet may be compressed and the aggregate packet may be decompressed at the controller before reading the aggregate wrapper of the aggregate packet. The plural data packets of the aggregate packet may be processed in parallel. The respective file to which each of the plural data packets is appended may be different between each packet of the plural data packets. The respective file to which each of the plural data packets is appended may be the same between all packets of the plural data packets. The respective file storage device on which lies the respective file to which each of the plural data packets is appended may be the same between all packets of the plural data packets. The respective file storage device on which lies the respective file to which each of the plural data packets is appended may be different between each packet of the plural data packets. The aggregate packet may comprise an aggregate wrapper and aggregate contents, the aggregate contents being encrypted, and the step of processing the aggregate packet may include decrypting the aggregate contents at the processing engine before recovering the plural data packets. The aggregate packet may comprise an aggregate wrapper and aggregate contents, the aggregate contents being compressed, and the step of processing the aggregate packet may include of decompressing the aggregate contents at the processing engine before recovering the plural data packets. Each of the plural data packets may be encrypted, and the step of processing the plural data packets may include decrypting each of the plural data packets. Each of the plural data packets may comprise a respective packet wrapper and respective packet contents, the respective packet contents being encrypted, and the step of processing the plural data packets may including decrypting the respective packet contents of each of the plural data packets. Each of the plural data packets may comprise a respective packet wrapper and respective packet contents, the respective packet contents being compressed, and the step of processing the plural data packets may include decompressing the respective packet contents of each of the plural data packets.

There is also disclosed a method of aggregating data, comprising: receiving at an aggregator plural data packets from plural source nodes, forming an aggregate packet at the aggregator by combining the plural data packets, and transmitting the aggregate packet from the aggregator to a central controller. In various embodiments, there may be included any one or more of the following features: the aggregate packet may be compressed before transmitting the aggregate packet to the central controller. The aggregate packet may be encrypted before transmitting the aggregate packet to the central controller. A wrapper may be added to the aggregate packet before transmitting the aggregate packet to the central controller. The plural data packets may be received at the aggregator in encrypted form. The plural data packets may be decrypted at the aggregator before forming the aggregate packet.

There is also disclosed a method of transmitting and recording data packets produced at plural source nodes, the method comprising: arranging plural nodes including the plural source nodes into a mesh, configuring the plural nodes of the mesh to relay data packets from the plural source nodes to a central controller, the central controller sending each data packet to a respective processing engine, and at the respective processing engine processing each data packet by appending it to a respective file on a respective file storage device.

There is also disclosed a method of transmitting and recording data packets produced at plural source nodes, the method comprising: arranging plural nodes including the plural source nodes into a mesh, configuring the plural nodes of the mesh to relay data packets from the plural source nodes to plural processing nodes, and at the respective processing engine processing each data packet by appending it to a respective file on a respective file storage device.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a schematic diagram showing an example seismic survey;

FIG. 2 is a schematic diagram showing the example survey of FIG. 1 with processing and storage units associated with the central controller;

FIG. 3 is a schematic diagram showing the example survey of FIG. 1 with processing and storage units associated with L2 nodes and the central controller;

FIG. 4 is a schematic diagram showing an example survey with processing and storage units associated with L1 nodes and the central controller;

FIG. 5 is a schematic diagram showing data flow to a central controller being passed to processing and storage units associated with the central controller;

FIG. 6 is a schematic diagram showing a fully encrypted data packet;

FIG. 7 is a schematic diagram showing a data packet with a plain text wrapper;

FIG. 8 is a schematic diagram showing an aggregate packet comprising fully encrypted data packets as shown in FIG. 6, with a plain text aggregate wrapper;

FIG. 9 is a schematic diagram showing an aggregate packet comprising a plain text aggregate wrapper and encrypted contents, the contents being a set of data packets with plain text wrappers as shown in FIG. 7;

FIG. 10 is a schematic diagram showing an example of the processing occurring at a sensor node and aggregator with fully encrypted packets and aggregate packets;

FIG. 11 is a schematic diagram showing an example of the processing occurring at a sensor note and aggregator with plain text wrappers for the packets and aggregate packets;

FIG. 12 is a schematic diagram showing an example of processing an aggregate packet, with incoming aggregate packets being received at a central controller and being distributed to processing engines;

FIG. 13 is a schematic diagram showing an example of processing an aggregate packet, with incoming aggregate packets being received at a packet processor and being distributed to further processing engines;

FIG. 14 is a schematic diagram showing an example of processing packets, with incoming packets being received at processing engines under direction of a central controller;

FIG. 15 is a flow chart showing an example process for generating aggregate packets, with plain text wrappers for the packets and aggregate packets; and

FIG. 16 is a flow chart showing an example process for receiving aggregate packets and storing data from the packets.

### DETAILED DESCRIPTION

This invention describes methods and protocols for reduction of over-the-air transmission, encapsulation of data and aggregate packets inside descriptive wrappers, and the use of the wrappers to offload processing and storage tasks from the CC to specialized processing engines. The wrappers also enable flexible compression and encryption techniques.

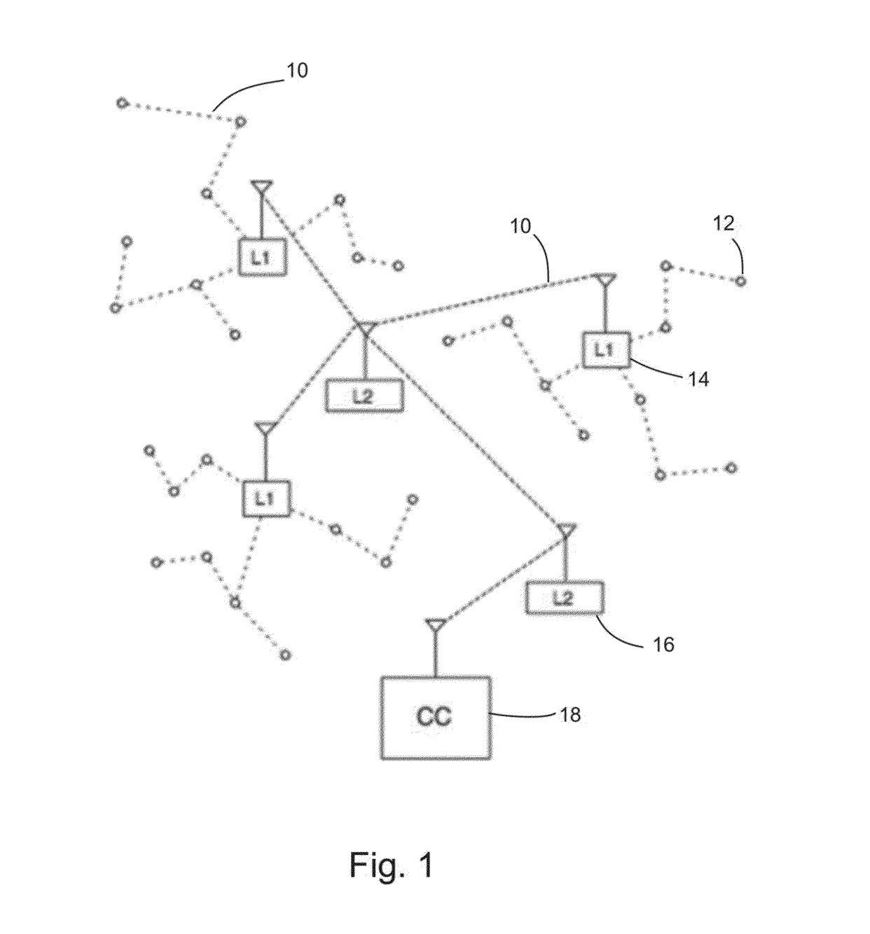

FIG. 1 shows an example survey having source nodes 12 (circles) feeding data to primary aggregators 14 (L1), which feed secondary aggregators 16 (L2), and finally the secondary aggregators pass the data to the central controller 18 (CC).

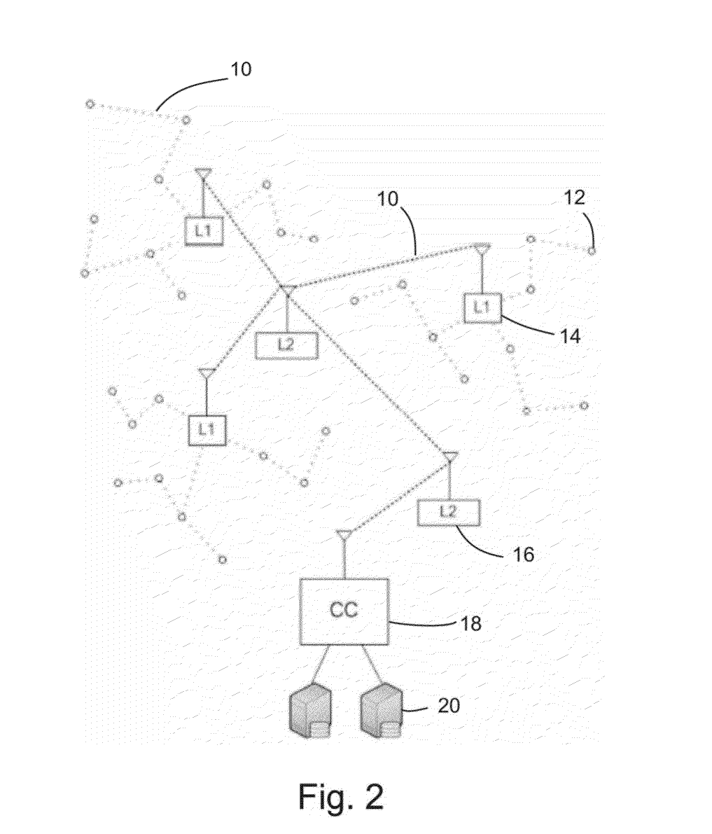

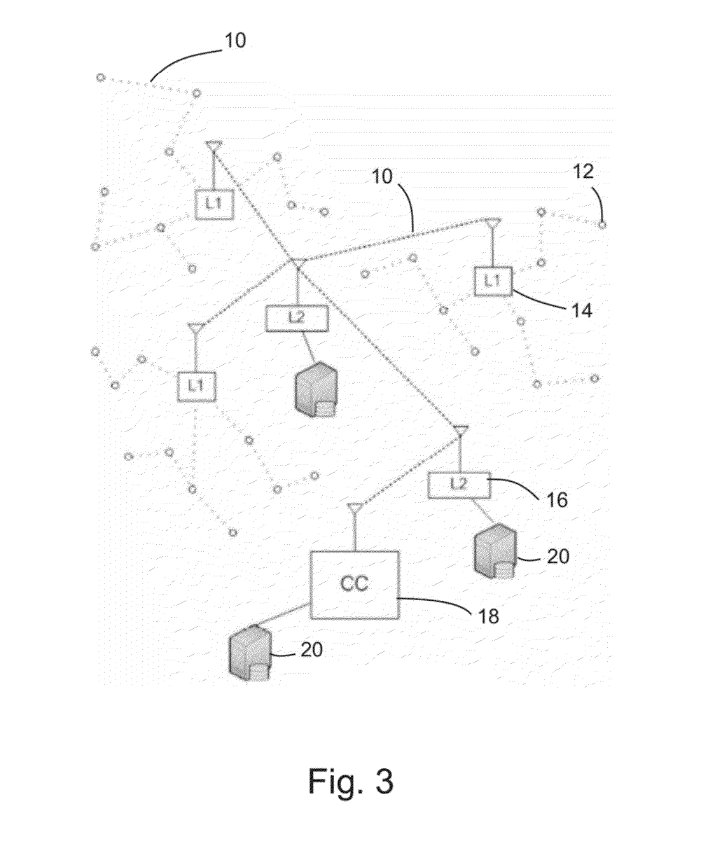

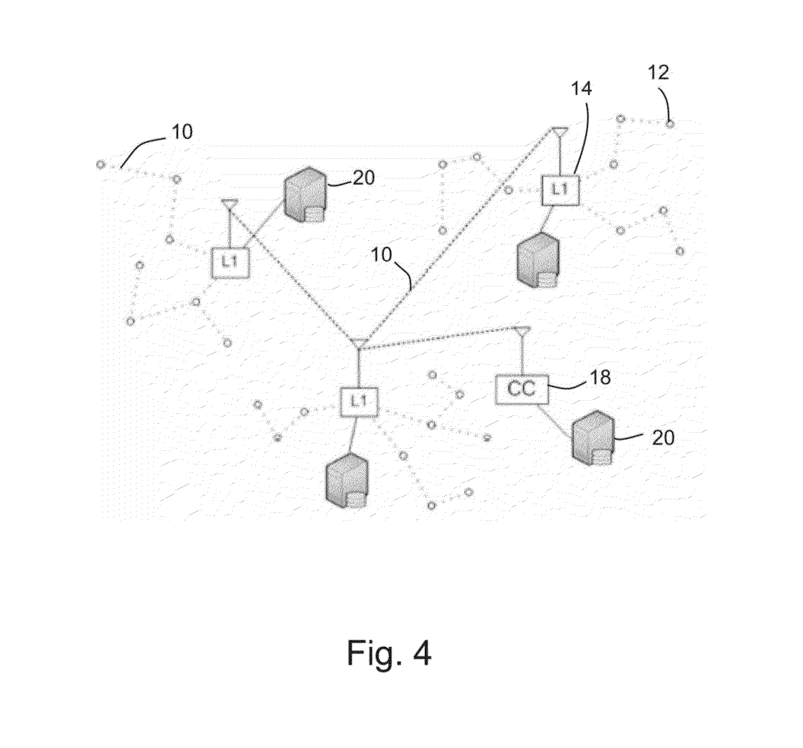

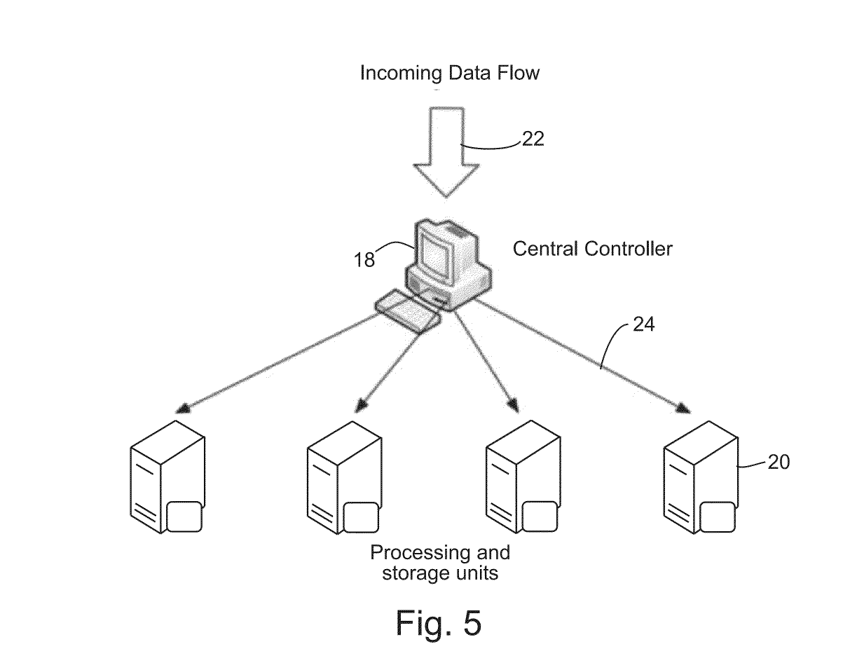

Instead of tracking (and waiting for) missing packets as in a conventional packet system, it is more efficient for nodes upstream from the central controller to package a complete set of contiguous data samples into the aggregate package, and to have processing nodes 20 downstream from the central controller to process and store incoming packets, as shown in FIG. 5. FIG. 2 shows the example survey of FIG. 1 but with processing nodes 20 downstream of the central controller to process and store incoming packets as in FIG. 5. In an embodiment, some information may be processed and stored other than downstream of the central controller, for example FIG. 3 shows the example survey of FIG. 1 but with processing nodes 20 associated with L2 aggregators 16 as well as with the central controller 18. FIG. 4 shows a different example network having no L2 aggregators but with processing nodes 20 associated with L1 aggregators 14 as well as with the central controller 18. FIG. 5 shows incoming data flow 22 being received at a central controller 18 and being distributed as outgoing data flows 24 to processing and storage units 20.

Reduction of Packet Size

To reduce transmitted packet size, parts of the packet already known at the CC are removed prior to over-the-air transmission, then added back at the collection unit (e.g. the central controller). Lossless compression may also be applied at the source node, and the compressed packet is transmitted through the mesh to the central controller. At the CC, incoming packets are processed by splitting the various streams, which are then passed to other processes or devices for de-compression and storage. The compression technique results in, on average, double the throughput performance of the existing system.

Pre-Processing the Data

Besides compression, other processing may be performed at the source node to create a smaller data packet to be transferred over-the-air.

One example is “stacking”, or combining a collection of seismic traces into a single trace. The stacking procedure may be performed at the source node, an intermediate node, or an aggregator. The stacked data packet is much smaller than the pre-stacked data packet, and transmitting that smaller packet means lower transmit power consumption, lower data transmission time, or both.

Other pre-processing may be performed by the originating or intermediate nodes, or an aggregator.

Packet Header Reduction

With many data collectors, the collector file format is designed to accommodate three channels per sensor, but if an attached sensor has only one channel, the data packets still include space for the non-existent data. In this case, the transmitting node may remove unused fields from the data packets prior to transmission, and “dummy” (or zero) fields may be inserted by the CC or processing/storage devices prior to storage of the data stream.

In some cases, parts of the data packet header do not change during the survey, and these parts may also be removed by the source node and replaced (with a copy of the known data) before the data is stored.

If the CC detects unchanging fields in the data packet header, it may signal the transmitting node to drop this part of the packet until either the CC commands otherwise or the information in the header changes. This sequence could be initiated by the transmitting node instead of the CC.

To enable this header or data compression, an indication of included data must be sent from the source node to the CC, preferably as part of the data packet. For example, if the transmitting node and the CC have agreed to drop some header fields, then, in the event that there is a change to one of the dropped fields, the transmitting node must inform the CC that fields have changed and the new values have been included in a packet. In a similar manner, if the transmitting node chooses to eliminate parts of the header it may indicate this information in the wrapper header.

One method to communicate which parts of the packet header are included in the packet and which have been removed is to include a bitmap. Each bit in the bitmap represents a field in the packet header, and if a bit is ‘1’, the field corresponding to that bit has changed and so therefore is included in the transmitted header. If the bit is ‘0’, the corresponding header field has not been transmitted, so the CC should insert the last received value for that field.

An example packet format is included in the Appendix. In the example, the VRSR2 packet includes eight 3-byte words in the header, an optional extended header, and one 3-byte word for CRC at the end of the packet.

The example packet includes an eight-word header, 24 bytes in length. In this case, a 3-byte bitmap can be used to indicate which fields are included in the transmission.

At the CC, the following rules are applied:

If a bitmap value is 1, the corresponding data in the header is read and processed.

If a bitmap value is 0 and the CC has previously received corresponding data for that bitmap location, the stored data is re-used.

If a bitmap value is 0 and the CC has not previously received corresponding data for that bitmap location, a default value is used.

For example, the first packet sent includes data in all fields except the unused “Reserved” fields, with a net savings of 5 bytes. At the control computer, the “Reserved” fields are filled with zeros. Following the transmission of the first packet, only changed data needs to be sent. Tables 1 and 2 illustrate this example.

TABLE 1
example packet header format and compression bitmaps

| # | Byte 0 | Byte 1 | Byte 2 | |
|---|---|---|---|---|
| 0 | Sentry = 0x7D | Len HI | Len LOW | |
| 1 | Device | Ext Her Type | Ext Her Len | |
| 2 | Shot ID MH | Shot ID ML | Shot ID LD | |
| 3 | Shot ID HI | Ep Num | Event | |
| 4 | Ser HI | Ser MID | Ser LOW | |
| 5 | Lat Num | Error | Sensor | |
| 6 | Reserved | Reserved | SVSM Addr | |
| 7 | Reserved | Reserved | Reserved | |
| 8 | Reserved Trs | Reserved Trs | Reserved Trs | |
| 0 | 1 | 1 | 1 | Compression Bitmap: |
| 1 | 1 | 1 | 1 | 1111 1111 1111 1110 0100 0000 |
| 2 | 1 | 1 | 1 | 16 data bytes transmitted |
| 3 | 1 | 1 | 1 | |
| 4 | 1 | 1 | 1 | |
| 5 | 1 | 1 | 1 | |
| 6 | 0 | 0 | 1 | |
| 7 | 0 | 0 | 0 | |
| 8 | 0 | 0 | 0 | |
| 0 | 0 | 1 | 1 | Compression Bitmap: |
| 1 | 0 | 0 | 0 | 0110 0011 1100 0001 0000 0000 |
| 2 | 1 | 1 | 1 | 7 data bytes transmitted |
| 3 | 1 | 0 | 0 | |
| 4 | 0 | 0 | 0 | |
| 5 | 1 | 0 | 0 | |
| 6 | 0 | 0 | 0 | |
| 7 | 0 | 0 | 0 | |
| 8 | 0 | 0 | 0 | |

For this example, note that the first field (byte 0.0) “Sentry” is a fixed value. Bytes 0.1 and 0.2 are likely to change packet-to-packet, but without the use of the extended header, bytes 1.0, 1.1, and 1.2 are not likely to change. Similarly, “Serial Number” (4.0, 4.1, 4.2) will not change for this device, and the “Reserved” fields remain unused. To mark these parameters, the compression bitmap is: 0110 0011 1100 0001 0000 0000, which results in a savings of 17 bytes at a cost of a 3-byte bitmap. This means a net savings of 14 bytes for every packet. Table 2 illustrates the actual data transmitted over-the-air for the compressed bitmap:

TABLE 2
example actual data transmitted

| | |
|---|---|
| Len HI | Compression Bitmap: |
| Len LOW | 0110 0011 1100 0001 0000 0000 |
| Shot ID MH | 7 data bytes transmitted |
| Shot ID ML | |
| Shot ID LO | |
| Shot ID HI | |
| Lat Num | |

In the event that the value of one of the fields changes, the changed data is sent and the compression bitmap is updated to indicate the addition of the changed fields. If the CC requires an update to the header information, it may send a request to the node, which would then transmit a full header and an all-one “0xff 0xff 0xff” compression bitmap.

There are also some cases where the bitmap may not be needed at all. For example, if the entire header is to be sent, there is no point in sending a header compression bitmap containing all 1's, and similarly, if no parts of the header are to be sent, then there is no point in sending a header compression bitmap containing all 0's. For this reason, a 2-bit field is included to indicate the whether the header compression bitmap, and, in the case where the bitmap is not present, to indicate whether the header is present:

Header Compression Bitmap Indication (Example):
00=no header bitmap present, full header included
01=no header bitmap present, no header sent (i.e. re-use last header values sent)
10=header bitmap present (i.e. partial header sent)
11=reserved

Table 3 shows an example header format.

Data Packet Compression

The structure and content of the sampled seismic data lends itself to simple and effective compression techniques. The fact that the sensor data occupies the vast majority of the transmitted packet means that compression of this data can yield a significant reduction in packet size.

For most applications, lossless compression is required. However, there are also cases where lossy compression is acceptable (e.g. real-time monitoring of a process or event). Because the signaling is provided in the packet wrapper, the operator or system is free to decide upon the most appropriate compression method to be applied to the packet.

One example of lossless compression is run-length encoding. Other techniques are well known and used in many other technical areas. Depending on the type of seismic data being transmitted (e.g. 2D, 3D, stacked), one type of compression may be more efficient than another. For this reason, it is beneficial to allow some flexibility regarding the type of compression used, and it is also beneficial to allow the transmitting node to select the optimal compression method. To enable the transmitting node to select an arbitrary compression mode, signaling is required to allow the CC to know what method was used to compress the data. For the data packets originating at the source node, packet wrappers (described below) are used to communicate the compression method (and other information) to the CC.

In the example the default packet format for the VRSR2 included in the Appendix, fields are included for a complete set of six sensors, each with three channels. Because these fields are included in the data packet, they are sent every transmission. For the case where not all the sensors are in use, the packet size can be reduced by indicating this (e.g. with another bitmap) and sending only data from active sensors. Other methods can be used to reduce the size of the packet by clever manipulation of the headers or data without suffering any loss of information at the receiver. The key is to indicate to the CC what (if any) pre-processing has been performed on the data packet so that a correct representation of the packet can be re-created before storage.

Selection of Packet Compression Techniques

If the packet contains a data portion that is very small in comparison to the header, then the compression bitmap and punctured header may be the best (and easiest) method of compression. On the other hand, if the data portion of the packet is significantly larger than the header, then a conventional compression scheme such as run-length encoding may perform better. For these reasons, it is beneficial to include a packet wrapper to identify the compression scheme in use on a packet-by-packet basis.

Note that there are some cases where lossy compression is acceptable. For example, real-time low resolution results may be more important than highly accurate readings. In this case, other compression algorithms are available and can be used and signaled to the CC. Also note that there may be cases when both header puncturing (or some other compression technique especially suited for the header or control signals) may be combined with a different compression technique.

Encryption

Once the data packet is compressed, data encryption (e.g. public key) may be applied at the first transmitter node (i.e. before any over-the-air transmission). This process ensures the confidentiality of the survey. There are many encryption schemes available, and with the aid of the packet wrapper, the system is free to use a specific method best suited to the application.

If, for example, private/public key encryption is used, the node applies the public key to encrypt the packet, while the CC applies its private key to decrypt the packet. Key exchange may take place as part of the source node discovery process, where nodes discovered by the CC or local aggregators are given the public key for data encryption. The same process may be applied at any time to change or update keys. Alternatively, keys may be stored on the nodes as part of the software load.

One potential issue occurs when the operator changes the public keys while the network is in use. This is another example where the packet wrapper may be used to allow this flexibility. In this case, the packet wrapper encloses the encrypted version of the compressed packet, and a value is included in the packet wrapper indicating which public key was used to encrypt the compressed packet.

When one of several encryption methods is be used on data packets, a value may be included in the packet wrapper to indicate which encryption method was used for the packet.

Decryption of the packet may not only occur at the CC, but may also be required at an intermediary node such as an aggregator. For example, the primary aggregators may decrypt and decompress packets from the source nodes so they may perform pre-processing or combine source packets for better compression. In this case, an encrypted link is created between the source node and an intermediary node (such as an aggregator), and another encrypted link is created between the intermediary and the CC, and packet wrappers are used in a similar manner between the source nodes and the aggregators, as well as between the aggregators and the CC.

Packet Wrapper

As mentioned earlier, the packet wrapper enables the transmitting node to identify key parameters about compression and encryption without revealing the contents of the data packet. The packet wrapper also allows the CC to offload processing tasks (like decryption, de-compression, and file streaming) to secondary processes or external hardware.

As the largest user of packet space, the data portion of the packet is most important when it comes to data compression. The data portion is also the most critical part of the packet to encrypt. Conversely, since the packet meta information is neither large in size nor sensitive, it should to be sent over-the-air without encryption. This meta information is sent as part of a packet wrapper. It may include information such as the identity of the originating node, the compression method used on the data, a header compression bitmap (as described earlier), a sequence number for the packet, information about the method or key used for encryption, or other high level meta data.

The packet wrapper may be applied to the compressed packet (i.e. the compressed packet and wrapper are encrypted), or it may be applied to the encrypted version of the compressed packet.

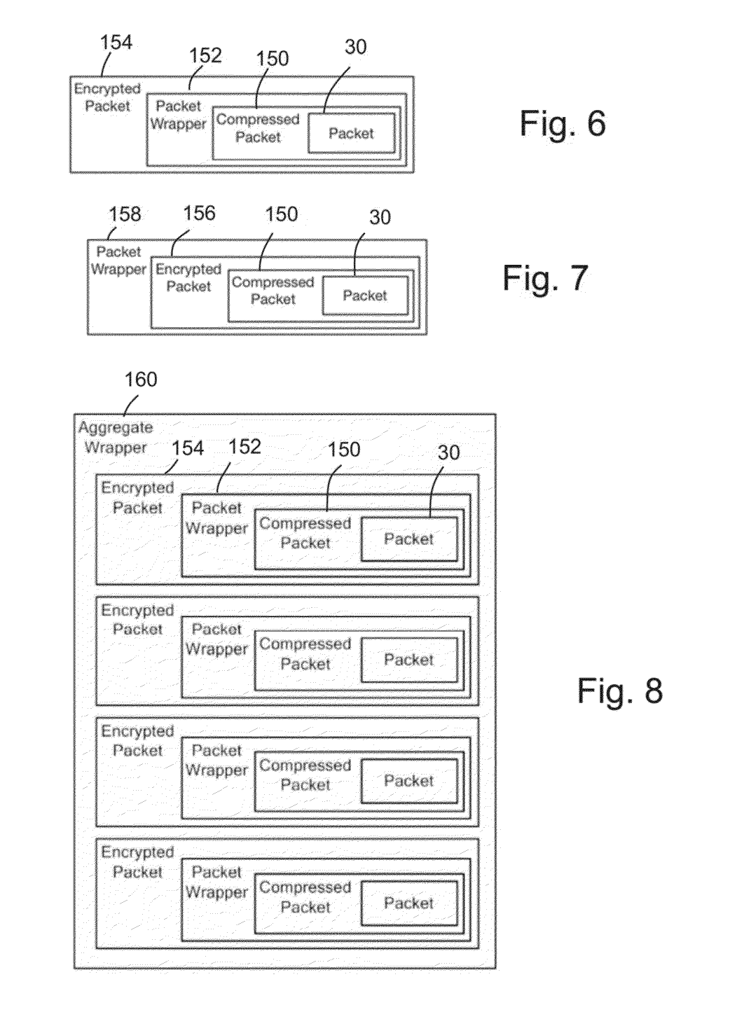

The benefit of applying the wrapper to only the compressed packet is that the wrapper itself is encrypted, which may be attractive if the system operator does not want even source IDs sent out over-the-air. Other methods of obscuring the source of the data are available, and it's more likely that the packet wrapper is applied to the encrypted version of the compressed data. A fully encrypted data packet is shown in FIG. 6. As shown in FIG. 6, a data packet 30 may be compressed to form a compressed packet 150, to which a packet wrapper may be applied to form a wrapped compressed packet 152, which may be encrypted to form a fully encrypted packet 154.

While applying the packet wrapper to the compressed packet (before encryption) hides all information about the packet, it limits flexibility of encryption methods. For example, the encryption method in use must be negotiated between the source and the CC and cannot be changed without another round of negotiation.

For example, a node identification number may be included. This ID number allows the CC to pass compressed packets to another process or processing hardware based on the node. This, in turn, allows the CC to segment the processing tasks and balance processing loads. The separate process or hardware can de-compress the packet and append the data to the file associated with that node. Also, the use of multiple packet processing devices reduces the processing requirements, hard drive write speed requirements, and (per processing device) hard drive storage capacity requirements. The packet wrapper may enclose the compressed packet or it may enclose the encrypted compressed packet. An example of a packet with a plain text wrapper enclosing an encrypted compressed packet is shown in FIG. 7. As shown in FIG. 7, a packet 30 may be compressed to form a compressed packet 150, which may be encrypted to form an encrypted packet 156, to which a packet wrapper may be applied to form a wrapped encrypted packet 158.

Assume, for example, source nodes have three compression techniques to choose from and encryption is optional (e.g. depending on whether the node is transmitting seismic data or system control/response messages). Also assume that one of the compression techniques is the header compression described earlier. In this example, three different encryption types are allowed, and there is a provision for an identifier to indicate which public key was used to encrypt the packet. The packet wrapper for this example would include a 3-byte value with the following encodings:

bytes 0-1: node ID (65536 unique node identifiers)

byte 2: compression/encryption information

bits 0-1: compression type (none, type 1, type 2, type 3)

bits 2-3: header compression
00=no header bitmap present, full header included
01=no header bitmap present, no header sent (i.e. re-use last header values sent)
10=header bitmap present (i.e. partial header sent)
11=reserved

bits 4-5: encryption type (none, type a, type b, type c)

bits 6-7: key value representing public key used to encrypt

Note that other information may also be included in the packet wrapper.

Aggregate Wrapper

When aggregators are in use, the primary aggregators (L1) harvest packets from source nodes, aggregate those packets, then pass the aggregated packets on to the CC, sometimes through secondary or even tertiary aggregators.

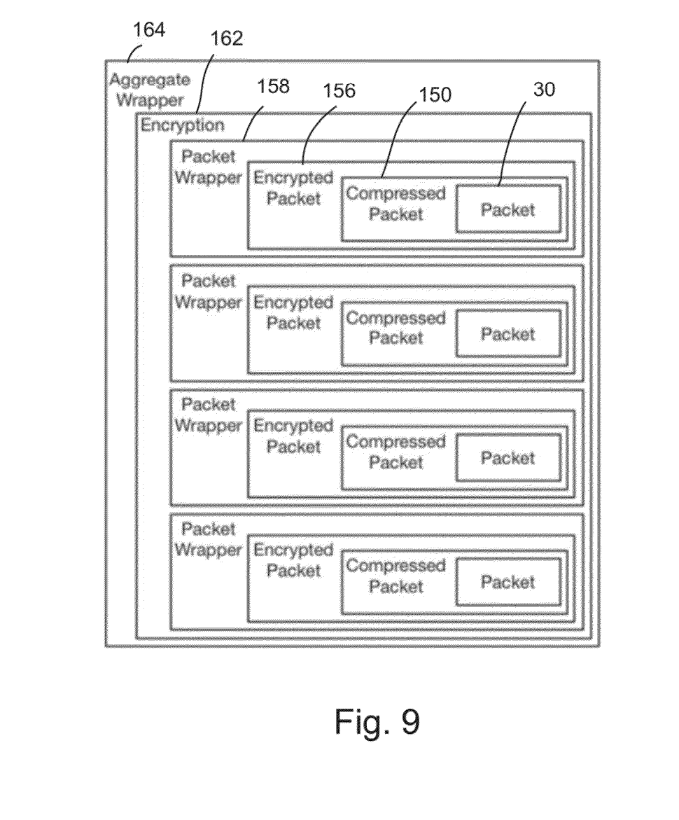

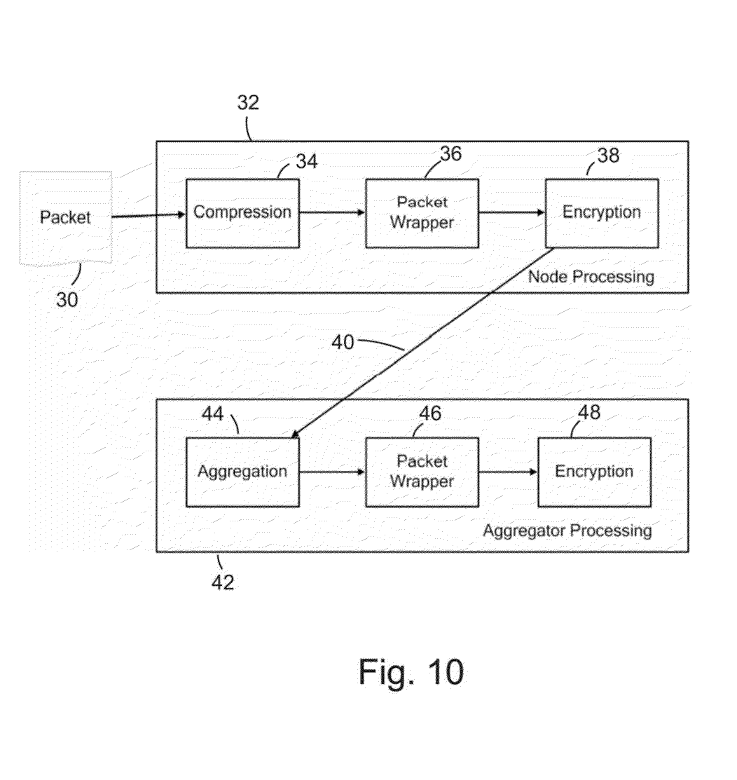

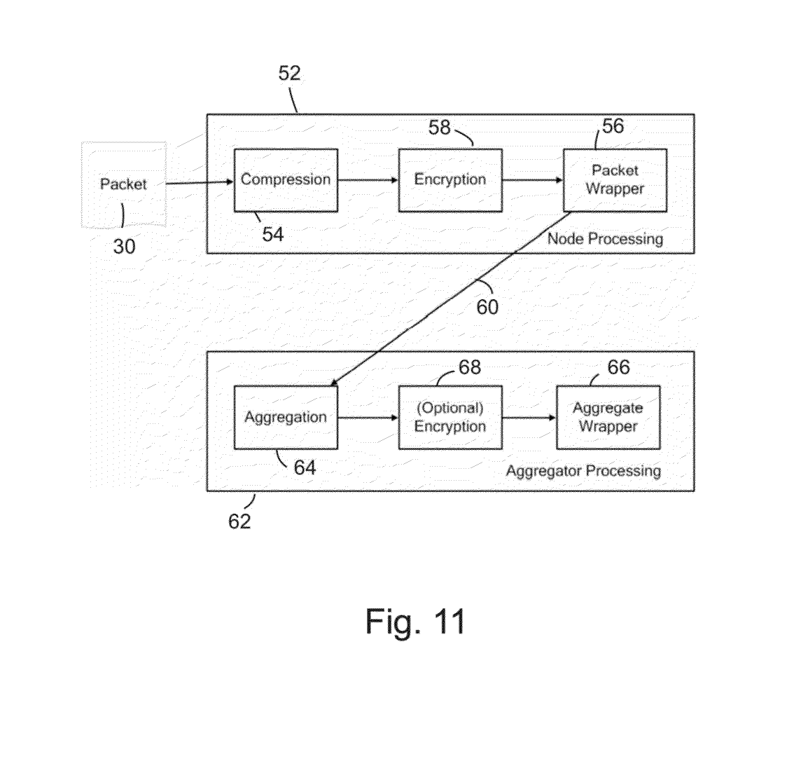

If the user is sensitive about plain-text information being sent over-the-air that would indicate which source nodes are aggregated by a given aggregator, a second encryption step may be applied, along with an aggregate wrapper. An example of this is shown in FIG. 9. As shown in FIG. 9, wrapped encrypted packets as in FIG. 6 are aggregated together and encrypted to form an encrypted aggregate 162, to which an aggregate wrapper is applied to form an encrypted aggregate packet 164. FIG. 8 shows an example of a different type of aggregate packet comprising fully encrypted data packets as shown in FIG. 6, combined with a plain text aggregate wrapper to form an aggregate packet 160 and without further encryption. Another possibility is to further encrypt the aggregate packet of FIG. 8 after applying the wrapper. FIG. 10 shows a process creating such an aggregate packet. A packet 30 is obtained at a source node and undergoes processing 32 at the source node. Processing 32 comprises compression in step 34, application of a packet wrapper in step 36, and encryption of the data packet in step 38. The fully encrypted data packet is then transmitted 40 to an aggregator node. The data packet and other data packets undergo processing 42 at the aggregator node to produce an aggregate packet. The processing at the aggregator node comprises aggregation of the data packets in step 44, application of the packet wrapper in step 46 and encryption in step 48. In an embodiment, the data packets may be decrypted at the aggregator before the aggregation step. FIG. 11 shows a process of creating a packet with a plain text wrapper that is aggregated also with a plain text wrapper. Packet 30 is obtained at a source node and undergoes processing 52 at the source node. Processing 52 comprises compression in step 54, encryption in step 58, and application of a packet wrapper in step 56. The data packet is then transmitted 60 to an aggregator node. The data packet and other data packets undergo processing 62 at the aggregator node to produce an aggregate packet. The processing at the aggregator node comprises aggregation of the data packets in step 64, encryption in step 68 and application of an aggregate wrapper in step 66.

Using an example similar to the one above for the packet wrapper, assume the aggregators also have three compression techniques to choose from, encryption is optional, but if encryption is used, three different encryption types are allowed. Finally, we will again assume that there is a provision for an identifier to indicate which public key was used to encrypt the packet. The aggregate wrapper for this example would include a 2-byte value with the following encodings:

bytes 0: aggregator ID (256 unique aggregator identifiers)

byte 1: compression/encryption information

bits 0-1: compression type (none, type 1, type 2, type 3)

bits 2-3: encryption type (none, type a, type b, type c)

bits 4-5: key value representing public key used to encrypt

bits 6-7: reserved

bytes 2-n: list of source node IDs in the aggregate packet

Note that other information may also be included in the aggregate wrapper.

Using Wrappers to Enhance CC Performance

In medium-to-large scale surveys, the CC may be responsible for the control, display, monitoring, and download of 10,000 or more nodes, hundreds of primary (linked to source nodes) aggregators, and dozens of secondary (linked to primary) aggregators. Even without the additional load of de-compression, appending downloaded data to 10,000 open files in addition to monitoring and controlling the mesh is a daunting task.

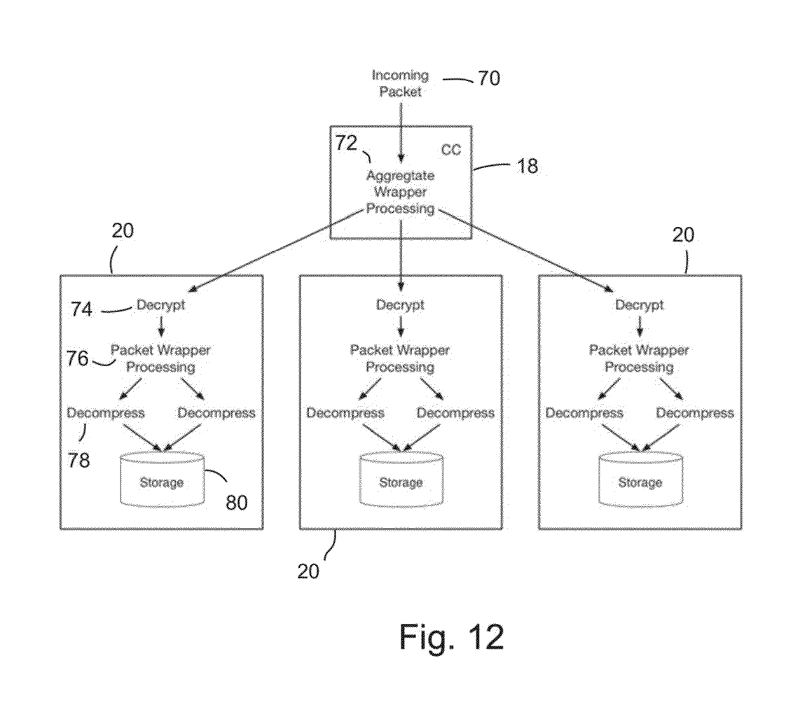

For this reason, it is desirable to offload as much work onto secondary processors. An example of a processing offload configuration is shown in FIG. 12.

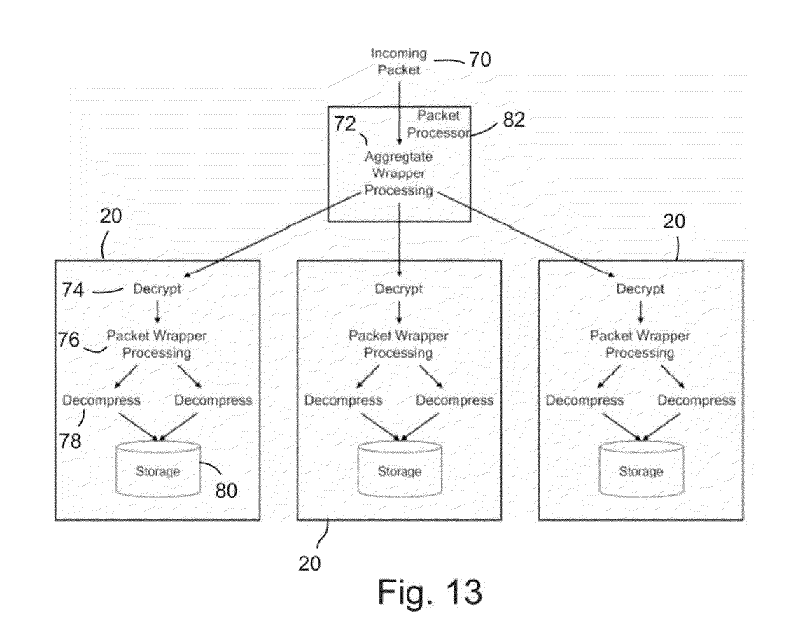

FIG. 12 shows the use of processing engines for the creation and maintenance of the file streams containing the downloaded data. While the packet wrapper provides meta information about the compressed/encoded packet, it also may be used to reduce the workload on the CC. In this example, packet processing by the CC is limited to reading the aggregate wrapper to determine which processing unit is to receive the incoming aggregate packet. An incoming aggregate packet 70, formed from plural data packets, is received by central controller 18. The central controller 18 reads the aggregate wrapper in step 72 and selects a processing engine 20 to send the aggregate packet to. The central controller may select the processing engine 20 to which to send the aggregate packet on the basis of, for example, the source of the aggregate packet. For example, for each aggregator the central controller 18 may send all the aggregate packets from that aggregator to a corresponding processing engine 20. In an embodiment where encryption is applied to the entire aggregate packet including the wrapper (as shown in FIG. 10) the central controller would decrypt the aggregate packet before reading the aggregate wrapper. Similarly, in an embodiment where the aggregate wrapper is compressed, or the whole aggregate packet including the aggregate wrapper is compressed, the aggregate wrapper or whole aggregate packet could be decompressed before reading the aggregate wrapper. In the embodiment shown the aggregate packet comprises an aggregate wrapper and encrypted aggregate contents. In this embodiment each processing engine 20, when receiving an aggregate packet from the central controller, decrypts the aggregate contents in step 74 and recovers the data packets from the aggregate packet (step not shown), processes the packet wrappers of the data packets in step 76 and decompresses the data packets in step 78 to record them on a storage device 80. In an embodiment in which the aggregate packet comprises an aggregate wrapper and compressed aggregate contents, the processing engine may decompress the aggregate contents before recovering the plural data packets. In an embodiment in which the data packets are encrypted, the data packets may be decrypted before reading the packet wrappers of the data packets. In an embodiment in which each of the data packets comprises a packet wrapper and packet contents, and the packet contents are encrypted, the packet contents may be decrypted before recording them on the storage device. In an embodiment in which each of the data packets comprises a packet wrapper and packet contents, and the packet contents are compressed, the packet contents may be decompressed before recording them on the storage device. The specific steps taken in processing the packets and the order of steps depends on the steps and order of steps taken in producing the packets. In various embodiments, there may be a one-to-one relationship between processing engines and storage devices, each processing engine may have more than one associated storage device or multiple processing engines may share a storage device. Instead of the CC reading the aggregate wrapper, a separate packet processor 82 may also take this role and distribute the packet to one of several processing engines as shown in FIG. 13. Note that one processing engine may serve multiple aggregators or source nodes. The processing engines may be part of the CC hardware or they may be external devices connected to the CC.

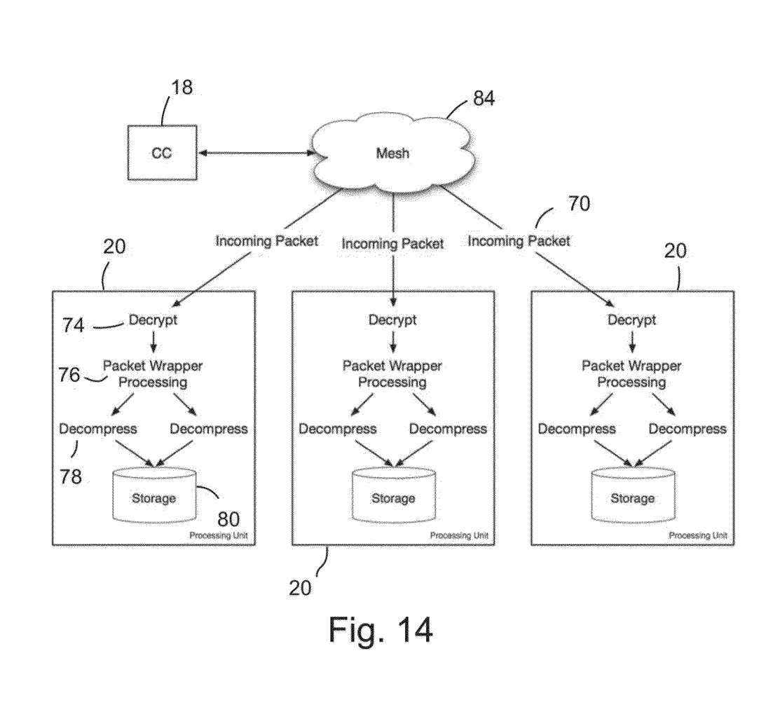

Alternatively, the CC may direct packet flows to processing units, either located near the CC (e.g. in the data van) or somewhere else in the mesh (e.g. adjacent to an L1 or L2 Aggregator) as shown in FIG. 14. FIG. 14 shows the CC 18 directing the nodes comprising the mesh 84, to cause the aggregate packets 70 to be sent directly to processing engines 20 instead of to the CC 18 or other centralized packet processor. Depending on the embodiment the nodes of the mesh may be configured to relay data packets from the plural source nodes to plural processing nodes with or without further direction from the CC.

Procedures

Initialization

As part of network initialization, the public keys may need to be distributed to the nodes. If the CC is responsible for decrypting the packets, it may choose to broadcast the public key sequence, it may unicast the sequence to each node as that node is discovered, or it may pass the public key on to data aggregation points for distribution. If other security measures are employed, passwords or keys may be shared in a similar manner. If commands and responses also require encryption, other key exchanges may take place to allow encrypted transfer in both directions.

The CC may also send configuration parameters to the nodes regarding compression methods. The CC may dictate a specific protocol to be used on all data packets, or it may inform the nodes of all the compression formats it is able to decompress (leaving the scheme selection to the nodes).

Commands

Similar to data, commands and responses may be compressed and/or encrypted. If there is a requirement to encrypt commands sent from the CC to aggregators or nodes, security parameters are configured as part of the initialization procedure described above.

Data Download

Packet Creation and Transmission

Data download may be in the form of real-time streaming or batch download. In either case, compression, encryption, and the packet wrapper are applied in a similar manner.

1. Following sensor data collection, packets (pre-determined size) are compressed by a node. If bitmap based header compression is performed, the unchanged parts are removed and the bitmap is constructed.

2. Encryption is performed on either the packet alone or the packet and the packet wrapper, depending on whether complete encryption is required.

3. If encryption is only performed on the packet, the packet wrapper is added to the encrypted bundle.

4. The new packet is now transmitted downstream, either to the CC (through the mesh) or to an aggregator.

5. If an aggregator is used, packets from one or more nodes are collected and aggregated until a super-packet size is reached, a time limit has expired, or some other trigger initiates the super-packet transmission. At this stage, another level of encryption and/or compression may be applied to the aggregate data. Optionally, the aggregator may decrypt and decompress the packets in order to combine them before transmission to the CC.

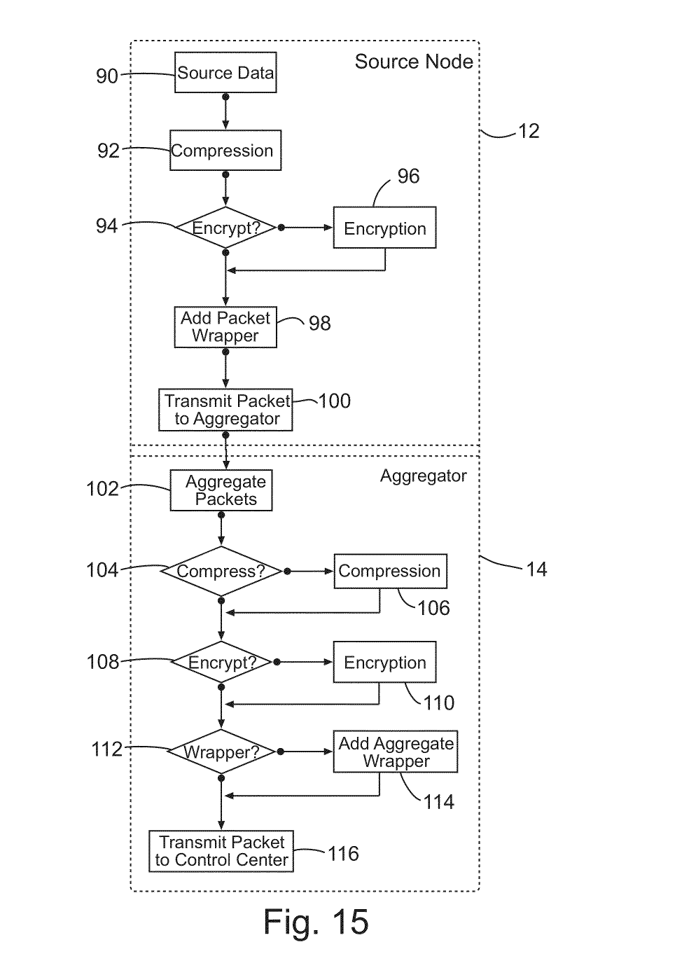

A flowchart depicting an example of the packet creation process (in an embodiment in which the wrappers, if present, are not encrypted) is shown in FIG. 15. At a source node 12, source data 90 is compressed in step 92. Depending on the embodiment, there may be a decision step 94 to determine if encryption is required. In some embodiments, the source node may be preprogrammed to encrypt or not to encrypt without a further decision step. If encryption is desired, in step 96 the compressed data is encrypted. In step 98 a packet wrapper is added to the encrypted, compressed data to produce a data packet that is transmitted to an aggregator in step 100. At the aggregator 14, in step 102 data packets collected from source nodes are aggregated to produce an aggregate packet. Depending on the embodiment, there may be decision steps 104, 108 and 112 to determine if compression, encryption, and wrapping respectively of the aggregate packet is required. In some embodiments, these choices may be preprogrammed without any further decision steps. If compression is desired, in step 106 the aggregate packet is compressed. If encryption is desired, in step 110 the aggregate packet is encrypted. If a wrapper is desired, in step 114 an aggregate wrapper is added. In step 116 the aggregate packet is transmitted to a central controller. In various embodiments, the steps shown in FIG. 15 may occur in different orders than shown. The aggregate packet may be transmitted to a different destination than the central controller, for example a packet processor as in FIG. 13 or a processing and storage unit as in FIG. 14. In another embodiment, where the data packets are encrypted before transmission of the data packets to the aggregator, the data packets may be decrypted at the aggregator before forming the aggregate packet.

Packet Processing
1. The CC receives the aggregate packet and separates it into streams based on the source (IP address) of the packet or the packet wrapper information. If the packet wrapper was encoded, the CC first decodes each packet to determine the source.
2. Each packet is passed to a processing stream for decryption, de-compression, and post-processing.
   a. The processing stream may be a separate process running on the CC processor, a separate processor device inside the CC enclosure, or a completely separate device operating external to the CC.
   b. Streams may be allocated to processing units based on source aggregator ID, source node ID (read from the packet wrapper or aggregator wrapper), or by some other grouping determined by the CC.
3. Once de-compressed and decrypted, the packet is appended to the file or directory of files associated with the source node.

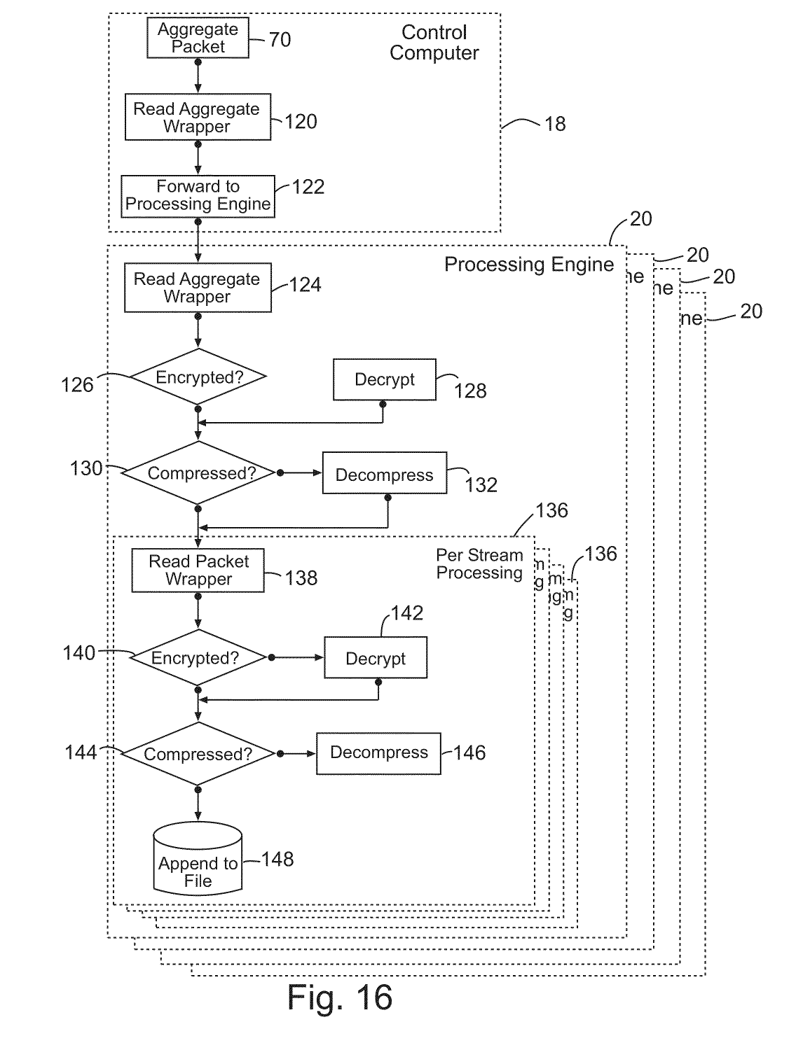

An example process for packet processing is depicted in the flowchart in FIG. 16. A central controller 18 receives an incoming aggregate packet 70 and in step 120 reads the aggregate wrapper. In step 122 the central controller sends the aggregate wrapper to a processing engine 20. There may be multiple processing engines and the central controller may choose which of the multiple processing engines to send the aggregate wrapper to depending on the aggregate wrapper. At the processing engine 20 in step 124 the processing engine reads the aggregate wrapper. Depending on the embodiment, there may be decision steps 126 and 130 to determine respectively if the aggregate packet is encrypted (and thus needs decryption) and if the aggregate packet is compressed (and thus needs to be decompressed). This determination may be made according to the aggregate packet wrapper. In some embodiments, the choices may be preprogrammed without any further decision steps. If decryption is required, in step 128 the aggregate packet is decrypted and if decompression is required, in step 132 the aggregate packet is decompressed. The aggregate packet is de-aggregated into data packets (step not shown) for processing in streams 136. Depending on the embodiment, the streams, each acting to process a data packet, may be carried out in parallel. In each stream, the data packet wrapper is read in step 138. Depending on the embodiment, there may be decision steps 140 and 144 to determine respectively if the data packet is encrypted (and thus needs decryption) and if the data packet is compressed (and thus needs to be decompressed). This determination may be made according to the data packet wrapper. In some embodiments, the choices may be preprogrammed without any further decision steps. If decryption is required, in step 142 the data packet is decrypted and if decompression is required, in step 146 the data packet is decompressed. In step 148, the data packet is recorded on a storage device. The recording of the data packet to a storage device may comprise appending the data packet to a file on the file storage device. Depending on the embodiment, the respective file to which each of the plural data packet corresponding to a single aggregate packet is appended may be different between each packet of the plural data packets or the same between all packets of the plural data packets. Depending on the embodiment, the respective file storage device on which lies the respective file to which each of the plural data packets is appended may be the same between all packets of the plural data packets, or different between each packet of the plural data packets.

TABLE 3
VRSR2 Header Format

| | Byte 0 | Byte 1 | Byte 2 |
|---|---|---|---|
| 0 | Sentry = 0x7D | Total File Length HI | Total File Length LO |
| 1 | Device Type | Extended Header Type | Extended Header Length |
| 2 | Shot Log ID MH | Shot Log ID ML | Shot Log ID LO |
| 3 | Shot Log ID HI | EP Number | Event Type |
| 4 | Serial Number HI | Serial Number MID | Serial Number LO |
| 5 | LAT Number | Error Flags | (0) Sensor Number |
| 6 | Reserved | Reserved | SVSM Logical Address |
| 7 | Reserved | Reserved | Reserved |
| 8 | Reserved for | Reserved for | Reserved for Transcriber |
| | Transcriber | Transcriber | |
| . . . | Extended Header | | |
| | SVSM-3 Sensor 1 Data | | |
| | SVSM-3 Sensor 2 Data | | |
| | SVSM-3 Sensor 3 Data | | |
| | SVSM-3 and VRSR2 Status | | |
| | SVSM-2 Sensor 1 Data | | |
| | SVSM-2 Sensor 2 Data | | |
| | SVSM-2 Sensor 3 Data | | |
| | SVSM-2 and VRSR2 Status | | |
| | SVSM-1 Sensor 1 data | | |
| | SVSM-1 Sensor 2 data | | |
| | SVSM-1 Sensor 3 data | | |
| | SVSM-1 and VRSR2 status | | |
| | SVSM 0 Sensor 1 data | | |
| | SVSM 0 Sensor 2 data | | |
| | SVSM 0 Sensor 3 data | | |
| | SVSM 0 and VRSR2 status | | |
| | SVSM 1 Sensor 1 data | | |
| | SVSM 1 Sensor 2 data | | |
| | SVSM 1 Sensor 3 data | | |
| | SVSM 1 and VRSR2 status | | |
| | SVSM 2 Sensor 1 data | | |
| | SVSM 2 Sensor 2 data | | |
| | SVSM 2 Sensor 3 data | | |
| | SVSM 2 and VRSR2 status | | |
| | Checksum HI | Checksum MID | Checksum LO |

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A method of processing an aggregate packet of a stream of aggregate packets, the aggregate packet formed by aggregating plural data packets, the method comprising:
a controller selecting a processing engine of a set of processing engines and causing the aggregate packet to be sent to the selected processing engine;
processing the aggregate packet at the selected processing engine to recover the plural data packets; and
processing the plural data packets at the selected processing engine by appending each of the plural data packets to a respective file on a respective file storage device.

2. The method of claim 1 in which the aggregate packet is received at the controller and is sent by the controller to the selected processing engine.

3. The method of claim 2 in which the aggregate packet comprises an aggregate wrapper and aggregate contents, the method further comprising the step of the controller reading the aggregate wrapper, and in which the controller selects the processing engine to which to send the aggregate packet based on the aggregate wrapper.

4. The method of claim 3 in which the aggregate packet is encrypted and the method further comprising the step of decrypting the aggregate packet at the controller before reading the aggregate wrapper of the aggregate packet.

5. The method of claim 3 in which the aggregate packet is compressed and the method further comprising the step of decompressing the aggregate packet at the controller before reading the aggregate wrapper of the aggregate packet.

6. The method of claim 1 in which the plural data packets of the aggregate packet are processed in parallel.

7. The method of claim 1 in which the respective file to which each of the plural data packets is appended is different between each packet of the plural data packets.

8. The method of claim 1 in which the respective file to which each of the plural data packets is appended is the same between all packets of the plural data packets.

9. The method of claim 1 in which the respective file storage device on which lies the respective file to which each of the plural data packets is appended is the same between all packets of the plural data packets.

10. The method of claim 1 in which the respective file storage device on which lies the respective file to which each of the plural data packets is appended is different between each packet of the plural data packets.

11. The method of claim 1 in which the aggregate packet comprises an aggregate wrapper and aggregate contents, the aggregate contents being encrypted, and the step of processing the aggregate packet including decrypting the aggregate contents at the processing engine before recovering the plural data packets.

12. The method of claim 1 in which the aggregate packet comprises an aggregate wrapper and aggregate contents, the aggregate contents being compressed, and the step of processing the aggregate packet including decompressing the aggregate contents at the processing engine before recovering the plural data packets.

13. The method of claim 1 in which each of the plural data packets is encrypted, and the step of processing the plural data packets including decrypting each of the plural data packets.

14. The method of claim 1 in which each of the plural data packets comprises a respective packet wrapper and respective packet contents, the respective packet contents being encrypted, and the step of processing the plural data packets including decrypting the respective packet contents of each of the plural data packets.

15. The method of claim 1 in which each of the plural data packets comprises a respective packet wrapper and respective packet contents, the respective packet contents being compressed, and the step of processing the plural data packets including decompressing the respective packet contents of each of the plural data packets.

16. A method of aggregating data, comprising:
receiving at an aggregator plural data packets from plural source nodes;
forming an aggregate packet at the aggregator by combining the plural data packets; and
transmitting the aggregate packet from the aggregator to a central controller.

17. The method of claim 16 further comprising compressing the aggregate packet before transmitting the aggregate packet to the central controller.

18. The method of claim 16 further comprising encrypting the aggregate packet before transmitting the aggregate packet to the central controller.

19. The method of claim 16 further comprising adding a wrapper to the aggregate packet before transmitting the aggregate packet to the central controller.

20. The method of claim 16 in which the plural data packets are received at the aggregator in encrypted form.

21. The method of claim 20 in which the plural data packets are decrypted at the aggregator before forming the aggregate packet.

22. A method of transmitting and recording data packets produced at plural source nodes, the method comprising:
arranging plural nodes including the plural source nodes into a mesh;
configuring the plural nodes of the mesh to relay data packets from the plural source nodes to a central controller;
the central controller sending each data packet to a respective processing engine; and
at the respective processing engine processing each data packet by appending it to a respective file on a respective file storage device.

23. A method of transmitting and recording data packets produced at plural source nodes, the method comprising:
arranging plural nodes including the plural source nodes into a mesh;
configuring the plural nodes of the mesh to relay data packets from the plural source nodes to plural processing nodes; and
at the respective processing engine processing each data packet by appending it to a respective file on a respective file storage device.
